(19) United States
(12) Patent Application Publication
(10) Pub. No.: US 2008/0226807 A1
(43) Pub. Date: Sep. 18, 2008

(54) Potato Fibres, Methods of Preparing Them and Their Use

(75) Inventors: Martin Lotz, Emlichheim (DE); Martin Jahn, Kasel-Golzig (DE); Paul Buntrock, Emlichheim (DE); Gerold Eggengoor, Wilsum (DE)

Correspondence Address: MILLER, MATTHIAS & HULL, ONE NORTH FRANKLIN STREET, SUITE 2350, CHICAGO, IL, 60606, US

(73) Assignee: EMSLAND STARKE GMBH, Emlichheim (DE)

(21) Appl. No.: 12/045,428

(22) Filed: Mar. 10, 2008

(30) Foreign Application Priority Data
Mar. 13, 2007 (DE) 102007012063.1-41

(51) Int. Cl. A23L 1/216

(52) U.S. Cl. 426/637; 426/455

(57) ABSTRACT

A method of preparing potato fibres includes the steps of: a) washing potatoes; b) optionally removing solid impurities and rinsing water adhering to the potatoes; c) grinding the potatoes into a pulp; d) separating potato fruit water; e) removing starch and optionally residual potato fruit water in order to obtain raw fibres; f) refining the raw fibres; g) mixing in potato fibres which have previously been dried; and h) drying the fibres; as well as potato fibres obtainable by that method and use thereof.

### FIELD OF THE DISCLOSURE

The present disclosure relates to a method of preparing potato fibres, potato fibres prepared in accordance with that method, and their use.

### BACKGROUND OF THE DISCLOSURE

A large number of plant fibres are known for human consumption and likewise for technical applications. Fibres are important, for example, for nutrition, in food technology as gelling agents and emulsifiers, and as structure-reinforcers or texturisers both in technical and in food applications. Fibres are particularly important as roughage, which is indispensable for human digestion.

First of all, fibres can be isolated in a targeted manner from plants, but secondly, they can also be prepared by recycling production residues, such as by processing pomace. Standard commercial fibres, such as fruit, vegetable or sugar beet fibres, involve various disadvantages, such as raw materials which are expensive and of limited availability and/or expensive production processes, limited functionality (e.g. water-binding ability), a distinct inherent colour, a pronounced taste of their own and in some cases an allergenic potential in contaminants which are inevitably present. Production is frequently expensive, e.g. in the case of citrus fibres because citrus fruits are an expensive raw material. Problems with allergies are known in the case of wheat bran, for example, which contains remnants of wheat gluten, so that it cannot be eaten by those suffering from coeliac disease.

A process for obtaining potato fibres is known from EP 0 413 681 B1. Those potato fibres overcome many of the above-mentioned disadvantages and make a valuable contribution to human nutrition, since they are produced from an allergen-free raw material, the raw material is available in large quantities and is less expensive than other raw materials for the preparation of plant fibres.

The potato fibres produced in accordance with EP 0 413 681 B1 do, however, possess unspecific characteristics, which fluctuate considerable, presumably owing to the production process. At the same time, potato fibres produced in this way have a high protein and glycoalkaloid content. It is well-known that glycoalkaloids are toxic, so that their content should be as low as possible, especially in foodstuffs. The potato juice (potato fruit water) obtained in the process and then re-used contains oxidised polyphenols, which give the fibres produced a dark, brownish colour and a certain bitter taste.

Even if no allergies are known from potato products, proteins are nevertheless always a latent source of allergies, and the protein content ought therefore always to be kept as low as possible. Furthermore, the residual proteins give the potato fibres, which are otherwise tasteless, a certain taste of potato.

### SUMMARY OF THE DISCLOSURE

It is one object of the present disclosure to provide a method of preparing potato fibres which overcomes the disadvantages of the state of the art. In particular, it is intended to provide a method which preserves the natural advantages of the potato fibres produced, especially their high water-binding capacity, freedom from allergens and high availability of the inexpensive raw material, and also provides potato fibres with a low content of glycoalkaloids, with a light colour, neutral taste and low protein content.

A further object is to provide potato fibres prepared accordingly, and their uses.

### BRIEF DESCRIPTION OF THE DRAWING

For a more complete understanding of this disclosure, reference should be made to the embodiments illustrated in greater detail on the accompanying drawing, wherein:

FIG. 1 is a flow chart schematically illustrating a method of preparing potato fibres according to the present disclosure.

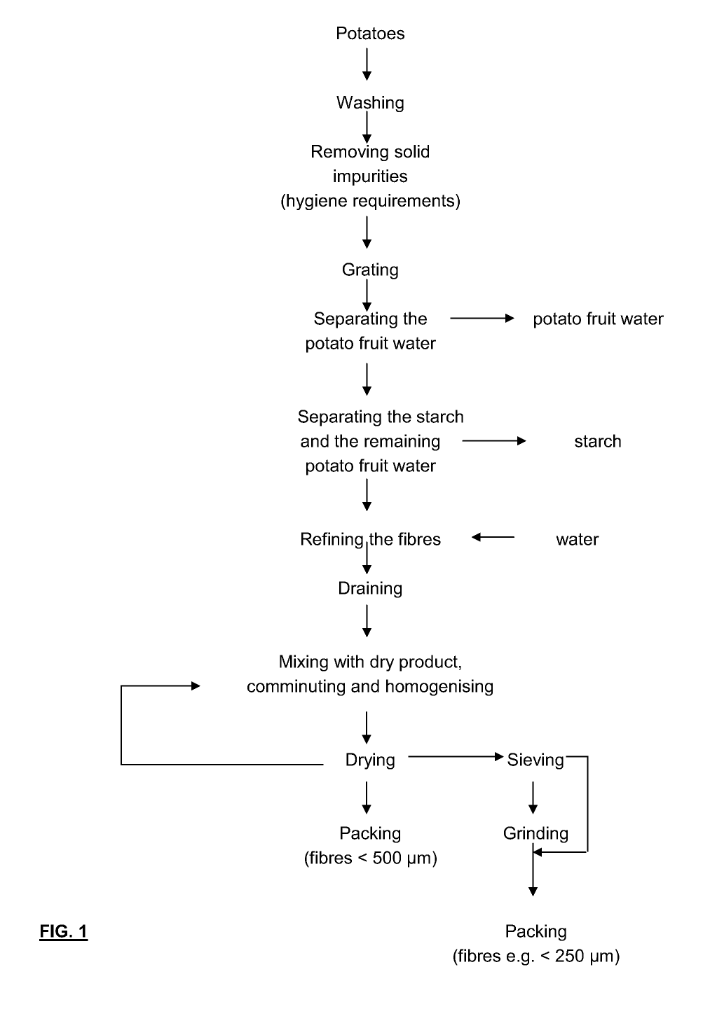

It should be understood that the drawing is not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

It has surprisingly been found that the methods disclosed herein for preparing potato fibres is extremely inexpensive, because no additional effort compared to the production of potato starch is necessary until the separation of the potato starch and fibres, and it is only after this point that the special production process for the potato fibres begins, which causes lower costs than the state of the art and at the same time improves the quality of the fibres compared to the state of the art. Starch potatoes are used as the starting materials, and these are inexpensive and available in large quantities.

A major advantage of the present methods is that potato fibres with a low glycoalkaloid content of only 100 to 120 ppm can be prepared, in contrast to a content of 320 to 450 ppm of glycoalkaloids if, for example, the method of EP 0 413 681 B1 is used. A content of about 100 to 120 ppm of glycoalkaloids corresponds to about half the levels which potatoes naturally contain. Since glycoalkaloids are known to be toxic, it is obvious that the potato fibres prepared according to the present methods are considerably healthier for the consumer than potato fibres prepared according to prior-art methods. The protein content of the potato fibres is 3 to 7%, which drastically reduces the allergenic potential of these fibres compared to the state of the art. Furthermore, the purity of the fibres increases in this way, which considerably enhances the possibility of using them in foodstuffs and in technology, since proteins cause unwanted and uncontrollable discoloration and chemical condensation and cleavage products especially in the event of shifts in pH and thermal loads. Other advantages are a lower ash content, a lighter colour and a large proportion of resistant starch of about 8 to 12%, which has a probiotic effect.

A survey of the composition of potato fibres prepared in accordance with the methods disclosed herein and potato fibres from the state of the art is shown in Table 1 below.

TABLE 1

| | | Potato fibres |
|---|---|---|
| | | according |
| | Potato fibres in accordance | to the state |
| | with the present disclosure | of the art |
| Moisture | 5-8% | 10-12% |
| Protein | 3-7% | 10-15% |
| Ash | 2-3% | 3-5% |
| Total Dietary Fibres (TDF)* | 70-75% | 58-65% |
| Resistant starch* | 12-14% | 11-12% |
| Digestible starch* | 8-9% | 9-15% |
| Water binding capacity** | 1:10-1:15 | 1:7-1:15 |

*Method LAOAC 985.29, 991.43, 2002.02
**Method 2.5% dry matter, 60 min stirring, 20 min centrifuging at 3,000 g

One feature of the methods disclosed herein is that the potato fruit water, which contains substances responsible for many negative properties, is separated from the fibres at as early a stage in the production process and as comprehensively as possible. The contact time between the fibres and the potato fruit water ought to be kept as short as possible in the process, so that its substances which are negative for fibres cannot penetrate the fibres, where they are retained and can no longer be eliminated from the fibres (oxidised phenols, which cause a dark colour and, as of a certain content, a bitter taste) or can only be eliminated with great effort and expense (proteins and glycoalkaloids).

In addition, the drying of the potato fibres can be optimised in the present method in such a way that it is possible to dispense with grinding the fibres and a fine-grained product is formed nevertheless, which is an advantage for the user, because further ingredients can be mixed in more easily and more quickly. This is achieved by the step of mixing with potato fibres which have already been dried previously. The desired binding of water from a mixture of ingredients also takes place more quickly if the exchange surface with the fibres, which is inversely proportional to the particle size of the fibres, is larger. At the same time, dispensing with a grinding step avoids the creation of an excessive amount of unwanted fibre dust, which causes losses in use and is a nuisance for employees working in the production process.

According to the methods disclosed herein, potatoes are first washed thoroughly, preferably in several stages, and rinsed in a final stage with clean water, e.g. drinking water or water of comparable quality. Optionally, though preferably, solid impurities are removed in a subsequent stage in order to satisfy hygienic requirements. One possibility of eliminating the impurities consists, for example, in manually removing such solids, which may take the form of pieces of weed or soil, for instance. At the same time, any rinsing water still adhering to the potatoes can optionally be removed as well, preferably by vibration, as a result of which the rinsing water is shaken off.

The now clean potatoes are ground into a fine pulp, and then the potato fruit water is removed as far as is technically feasible. The potato fruit water is preferably separated with horizontal centrifuges, known as decanters, though in principle all known separators, preferably centrifuge separators, are suitable for this purpose. Together with the potato fruit water, substantially all the substances which are harmful for the quality of the potatoes are removed, i.e. mainly polyphenols, the enzyme polyphenol oxidase PPO, protein, glycoalkaloids, and also soluble salts and minerals. In this step (step d)), a removal efficiency of the potato fruit water of about 50% to about 70% of the total potato fruit water is achieved.

Remaining in the solids fraction after the separation of the potato fruit water, are the solids starch and fibre solids, possibly together with a residual amount of potato fruit water. The solids fraction (pulp) is then separated into starch and fibres by rinsing with water, which may optionally be recycled, preferably in centrisieves, and may therefore contain certain amounts of potato fruit water, in the course of which the presence of the water means that the grains of starch occur as raw starch milk in substantially liquid form and can subsequently be subjected to starch refining. The raw fibre, which has now already been largely liberated from disturbing contaminants, is separated from the liquid fraction, so that, when centrisieves are used for example, it remains on the sieve covers, and is subsequently likewise refined. Apart from the centrisieves mentioned, hydrocyclones and other separators may also be used which exploit the differences in density between light fibres and heavy grains of starch.

In the present method, the grinding of the potatoes is preferably carried out in such a way that, on the one hand, the cell walls of the potatoes are destroyed to such an extent that the grains of starch are revealed to the extent necessary and can subsequently be recovered, but that the fibre particles, which consist of the skins and cell wall material, remain bigger than the grains of starch, so that they can be isolated by means of the difference in size.

After the starch has been removed, the raw fibres are refined by washing with water. In this context, it is particularly preferred to achieve an intensive mixing of the fibres with the water so that the cost and the burden on the environment because of high water consumption can be kept to a minimum. The above-mentioned centrisieves are excellently suited to this purpose, though other techniques, such as impeller-type mixers followed by centrifugation (decanter, separator, hydrocyclone), may also be used. It is particularly preferred to refine the fibres using fresh water, specifically in several stages and in counterflow. Some of the effluent from this refining process can be used for step (e), while the rest is disposed of.

Following the refining step, the treated fibres, which already have a relatively high dry solids content, are preferably pre-drained, preferably by means of a centrifuge, particularly preferably a decanter centrifuge. Other dewatering techniques, such as pressing, result in higher dry solids contents than centrifuging, but the effort needed, relative to the amount of water separated, is disproportionately high, since, for reasons of hygiene and nutrition physiology, none of the additives which are customary when the fibres are used as animal feed, for example (such as lime or flocculation polymers), can be used.

In the following step, the pre-drained fibres are mixed with already dried fibres in order to be able to make up the fibres as a finished product in one pass through the dryer. The mixing here should be very intensive in order to avoid wet and dry pockets, which might disturb the drying step. The mixing results in good homogenisation and loosening of the material obtained and comminutes the lumps. The mixing can preferably be achieved with paddle mixers. Mixing can also be achieved by using a (small) mill.

After the mixing, the fibres are dried further, it being possible to use any of the known types of dryers for solid materials, such as fluidised bed, dispersion, air-lift or spray dryers. The dry material obtained after drying can, at least partially, be returned to the cycle and added to the wet fibres in step g). When dry material is returned in this way, it is usually also referred to as “add-back”. As a result of the intensive mixing, fibre particles are obtained during the drying step which, can be less than 500 μm in size, without any additional grinding step. If, however, fibres are desired which are smaller in size, such as no more than 250 μm, there will be no difficulty, according to a rough estimate, in screening across a sieve with a mesh of 250 μm, though this advantageously requires a smaller mill and less energy input than in the state of the art. At the same time, the fibres are treated gently in this way, and their technical characteristics in application, especially their water binding capacity and their light colour, are preserved better. In addition, dispensing with grinding, or at least restricting it to a partial stream, means that the grains of starch still present are not damaged by the heat inevitably generated in the process, as a result of which they do not lose their digestion-resistant and thus prebiotic character.

After the drying stage, there can preferably be a fire classification step, preferably over 1,000 μm, in order to remove burnt and agglomerated pieces and lumps of fibre and foreign material (e.g. pieces of metal) from the system in order to render everything hygienic for the purposes of food technology and ready for final making up. This fire classification is carried out as a matter of principle in all bulk products, irrespective of whether they are of natural or technical origin. Fire classification is thus state of the art.

After that, the fibres can be packed and stored appropriately, or used.

The potato fibres produced consist substantially of the cell material and the skin parts of the potatoes. It is the skin residue, part of which is removed during the thorough washing, which contains the lignin, which accounts for about 2 to 3% by weight of the fibre material, based on the total weight of the potato fibre. The cell walls consist of cellulose, hemicellulose and pectins. In addition to these typical fibre materials, the potato fibres also contain remnants of minerals (ash), protein and starch in resistant and digestible form. The fibres obtained using the methods disclosed herein possess greater purity than prior art potato fibres, since the amounts of foreign components contained, protein and minerals, at 2 to 3% by weight and 3 to 7% by weight respectively, are considerably lower than in the state of the art. The starch content as a whole is quite similar to the state of the art, but the fibres obtained according to the present methods contain a high proportion of resistant starch, which is only metabolised in the large intestine and therefore produces a healthy, important, positive, prebiotic effect by exerting a positive influence on the intestinal flora. The resistant starch amounts to about 8 to 12% by weight, based on the total dry fibrous substance. Another major advantage of the fibres is the roughly ⅔ reduction in the content of glycoalkaloids, which are a powerful toxin, which is why green potatoes and tomatoes should not be eaten as a matter of principle, as is well-known, because they contain glycoalkaloids in concentrated form. The colour of the potato fibres produced in by the methods disclosed herein is light, with little discoloration and with a creamy tinge.

As already explained above, the advantages of the present methods are achieved in particular by the feature that the potato fruit water, together with its disturbing substances, is separated at an early stage of the production process and to the greatest possible extent. Other important aspects are the gentle drying, dispensing with grinding, provided the grain size required by the application permits this. The early separation of the potato fruit water prevents polyphenols and PPO from penetrating the fibres. Together with the gentle drying, only a slight discoloration (creamy) is caused, in contrast to the orange or brown discoloration of potato fibres in the state of the art. A lower lignin content additionally reduces the grey cast of the fibres, as a result of which they appear lighter (whiter). The colour values are expressed or measured, as is known in the state of the art, in L⁺ values (whiteness, brightness) and b⁺ values (yellow/orange cast).

The most important functional property of the fibres is their water-binding capacity, which originates substantially from the actual fibre material, i.e. cellulose, hemicelluloses and pectins. Hemicelluloses and pectins are generally subsumed under soluble fibres, whereas cellulose and, to a limited extent, lignin constitute the insoluble part of the fibres. Of interest from the point of view of food physiology are the insoluble substances, known as roughage, since they stimulate the intestine to greater mechanical movement, which leads to a more regular and softer stool. There are also discussions over whether the risk of cancer of the intestine is reduced, though it is not quite clear whether the prebiotic effect of the soluble fibres does not likewise play a certain role. The unusually high water-binding capacity of the potato fibres of about 1:15 to 1:20, which is hardly matched by any other natural fibres, makes them interesting for a wide range of applications in foodstuffs and technology. Since the water binding can take place both chemically by the attachment and binding of water particles to the fibre material and physically by deposition in cavities, it becomes clear how important the gentle treatment of the fibres is, which is achieved with the method disclosed herein. As a result of the grinding, the ends of the fibres split open and the volume of the cavities available for deposition is reduced, which makes its effect felt in reduced water binding. Smaller particle sizes, above all dust-fine particles, also cause the ratio of storage volume to fibre mass to shift more and more to the detriment of the water-binding volume.

The following examples describe the advantageous use of the potato fibres obtained using the present methods.

EXAMPLE 1
(Tagliatelle (ribbon noodles))

| | |
|---|---|
| 420 g | durum wheat, ground |
| 280 g | water |
| 22 g | potato fibres |
| 8 g | salt |
| 730 g | |

### Production:

First of all, all the ingredients are placed in a bowl and mixed together for 2 minutes. Then the mixture is kneaded at a higher speed into a compact dough, which is no longer moist, and which no longer sticks. The dough is shaped into a ball, covered with cling film and left to stand for 1 hour. After that, the dough is rolled out on a lightly floured surface into a thin slab and fed into the pasta machine. Now the tagliatelle are cut and hung up to dry or blanched briefly, in order then to freeze them.

With reference to the tagliatelle produced, the advantages of the potato fibres obtained using the present methods become apparent. The tagliatelle preserve a high content of roughage, which leads to a health benefit. In addition, the higher water-binding capacity of the pasta means that less material has to be used.

EXAMPLE 2
(Rolls)

| | |
|---|---|
| 1,010 g | wheat flour type 550 |
| 655 g | water |
| 50 g | yeast |
| 44 g | potato fibres |
| 20 g | table salt |
| 10 | mono and diglycerides of edible fatty acids |
| 9 g | sugar |
| 730 g | |

### Production:

Dissolve the yeast in some of the water. After that, place the dry ingredients in a bowl and mix them for 2 minutes with dough hooks and then process at medium speed into a viscous dough. Leave the dough to prove for 10 minutes. Shape the dough blanks, leave them to stand for 20 minutes and then press down blisters. First allow to prove for 30 minutes in a combination steamer at 35° C. and 75% air humidity, then bake for 13 minutes at 180° C. and 60% humidity. Finally finish baking for 5 minutes at 190° C. with hood open.

The use of the potato fibres in the production of rolls results in a 2.6% reduction in baking loss. Furthermore, more water is bound in the baked product, and the crumbs remain pleasantly moist, which likewise results in a positive feeling in the mouth.

EXAMPLE 3
(Hamburgers)
Ingredients for approx. 11 hamburgers of 70 g each:

| | |
|---|---|
| 533.5 g | lean beef (haunch) |
| 160 g | belly of pork (lard) |
| 10 g | salt |
| 0.5 g | ground black pepper |
| 24 g | potato fibres |
| 72 g | water |
| 800 g | |

### Preparation:

Mince beef and pork belly through the 5 mm disk of a mincer. Add spice mixtures and the salt and blend thoroughly. Shape meat mixture into round hamburger patties and cook them dry for 15 minutes at 150° C. in a convectomat.

When the potato fibres are used in the manufacture of hamburgers, the fat and water-binding capacity is advantageously enhanced; when more than 3% by weight of potato fibres are used, for example, no escaping water is observed any longer.

EXAMPLE 4
(Ice cream)

| | |
|---|---|
| 2.8 g | mono and diglycerides of edible fatty acids (E 471) |
| 95 g | crystal sugar, fine |
| 0.1 g | carotene |
| 60 g | clarified butter |
| 0.2 g | vanilla pod |
| 7 g | Bourbon vanilla sugar |
| 1.2 g | thickening agent (locust bean flour [E 410]/carrageenan |
| | [E 407]) |
| 26 g | whole milk powder |
| 6 g | lemon juice |
| 250 g | cream |
| 370 g | milk 3.5% fat |
| 1 g | salt |
| 4.1 g | potato fibres |
| 823.4 g | |

### Preparation:

Heat milk and cream to 70° C. Then add dry ingredients and stir in until everything has dissolved completely (do not boil, since this causes separation). Beat mixture with hand mixer for 5 minutes at highest speed (at 70° C.), then allow the mixture to cool for about 20 minutes in the freezer (do not allow to crystallise). Now beat for another 5 minutes. Then pour the mixture into an ice-cream machine and allow to freeze in approx. 45 minutes to −6° C. Finally, refill the ice cream, label and keep in freezer.

The use of the potato fibres in the production of ice cream means that more roughage can be incorporated, which is beneficial to the health. Because of the reduced crystallisation, it is possible to integrate more water. In particular, the ice cream produced was also found to cause a pleasant feeling in the mouth.

EXAMPLE 5
(Fine cakes (Madeira cake))

| | |
|---|---|
| 87.5 g | wheat flour type 405 |
| 87.5 g | wheat starch |
| 125 g | butter |
| 0.5 g | salt |
| 10 g | baking powder |
| 125 g | sugar |
| 125 g | whole egg |
| 18 g | potato fibres |
| 4 g | vanilla sugar |
| 33 g | water |
| 4.5 g | lemon juice |
| 620 g | |

The ingredients listed were used to make a cake mixture, which was placed in a loaf baking tin. The mixture was then baked in the tin for 35 minutes at 190° C.

Even in the production of cakes and pastries, the increased proportion of roughage can lead to a health benefit. In addition, the cake stays fresh for longer because of the better water binding. In the cake made in Example 5, the moisture content after 13 days dropped from 23.9% to 16.6%, whereas the moisture content in a conventional standard cake without potato fibres dropped from 20.7% to 14.0%. This may be advantageous for the delivery logistics of large bakeries via temporary storage in warehouses, all the way to the supermarket, so that a longer “best before” date can be stated for the product in the supermarket.

Technical applications that may be mentioned for the potato fibres produced according to this disclosure include their use in asphalt and joint filler or pointing mortar for reinforcement purposes. Reinforcement is understood to denote the stiffening of a solidified liquid mixture by means of a skeleton of solid material. Probably the best-known example is the steel structure in reinforced concrete, which is known as reinforcing steel.

While such embodiments have been set forth, alternatives and modifications will be apparent in the above description to those skilled in the art. These and other alternatives are considered equivalents in the spirit and scope of this disclosure and the appended claims.

What is claimed is:

1. A method of preparing potato fibres comprising the steps of:
a) washing potatoes;
b) optionally removing solid impurities and rinsing water adhering to the potatoes;
c) grinding the potatoes into a pulp;
d) separating potato fruit water;
e) removing starch and optionally residual potato fruit water in order to obtain raw fibres;
f) refining the raw fibres;
g) mixing in potato fibres which have previously been dried; and
h) drying the fibres.

2. The method of claim 1, in which the washing in step a) is carried out in a final step with drinking water and/or water of comparable quality.

3. The method of claim 1, in which, in step b), impurities are removed manually and/or water is removed by vibration.

4. The method of claim 1, in which, in step d), the separating is performed with centrifugal separators, preferably horizontal centrifuges.

5. The method of claim 1, in which, in step d), 50% to 70% of the total potato fruit water is separated.

6. The method of claim 1, in which the separating in step e) is performed in centrisieves and/or hydrocyclones.

7. The method of claim 1, in which, after step e), separated starch is subjected to starch refining.

8. The method of claim 1, in which the grinding in step c) is carried out in such a way that fibre particles remain bigger than grains of starch in the potatoes which are substantially revealed by the grinding.

9. The method of claim 1, in which the refining of the raw fibres in step f) is performed by rinsing with water, especially over centrisieves, decanters and/or separators.

10. The method of claim 1, in which the fibres are pre-drained after step f) and before step g), preferably using a centrifuge.

11. The method of claim 10, in which a mass ratio of wet to dry fibres is about 1:1 to 1:6.

12. The method of claim 1, in which, after step h), the fibres obtained are ground.

13. The method of claim 1, in which the fibres are fire-classified after drying in step h).

14. Potato fibres obtainable by a method as claimed in claim 1.

15. The potato fibres of claim 14, further comprising a glycoalkaloid content of 100 to 120 ppm.

16. The potato fibres of claim 14, further comprising a lignin content of about 2 to about 3% by weight, based on the total weight of the potato fibres.

17. The potato fibres of claim 14, further comprising a content of resistant starch of about 8 to about 12% by weight, based on a total weight of the potato starch.

18. The potato fibres of claim 14, further comprising a protein content of about 3 to about 7% by weight, based on a total weight of the potato fibres.

19. The potato fibres of claim 14, further comprising an ash content of about 2 to about 3% by weight, based on a total weight of the potato fibres.

20. Use of potato fibres as claimed in claim 14 as a component of foodstuffs and for technical applications.

21. The use of claim 20 in meat and sausage products, bakery products, baby food, functional foods, asphalt, joint filler or pointing mortar for reinforcement purposes.
